(19) United States
(12) Patent Application Publication
(10) Pub. No.: US 2009/0100102 A1
(43) Pub. Date: Apr. 16, 2009

(54) Film School Database

(76) Inventor: Joshua Brandon Pancer, Redlands, CA (US)

Correspondence Address: Joshua Pancer, 221 Eucalyptus Drive, Redlands, CA, 92373, US

(21) Appl. No.: 12/245,731

(22) Filed: Oct. 4, 2008

Related U.S. Application Data
(60) Provisional application No. 60/977,823, filed on Oct. 5, 2007.

(51) Int. Cl. G06F 17/30

(52) U.S. Cl. 707/104.1; 707/E17.01

(57) ABSTRACT

The invention is an electronic networking system assisting college “film students” in the process of locating other “film students” as well as their fellow students' film projects. The system includes features to search for projects and students within particular schools or throughout a plurality of schools. This system provides contact information and/or a means of contact, including an SMS text messaging ability.

This application claims the benefit for US provisional application #: 60/977,823

### FIELD OF THE INVENTION

This invention is a system which is currently taking the form of a website, which works in conjunction with email and mobile phones.

### BACKGROUND

Films are known to be one of the most, if not the most, collaborative art form. As is made obvious when viewing film credits at the end of a movie, film crews can consist of hundreds of individuals.

Film School Students have a very difficult time for a variety of reasons, but it typically comes down to two main problems, “Money” and “people”. These problems are actually linked in some ways, as occasionally students will be forced to give up on finding people to work for free and may have to expend money to get people.

### SUMMARY OF THE INVENTION

The Film School Database is a website assisting film students in the process of locating the recourses available at their school, as well as other schools. The website allows students to solve the “people” problem by giving them access to student and project search tools, which don't currently exist in any other form. Other features of the Film School Database offer further management tools throughout the filmmaking process.

### BRIEF DESCRIPTION OF THE DRAWINGS

The drawings described and shown are actual screenshots of the invention in its current state.

FIG. 1: The homepage shows basic information to students who are customers and to students who are potential customers and provides a login field.

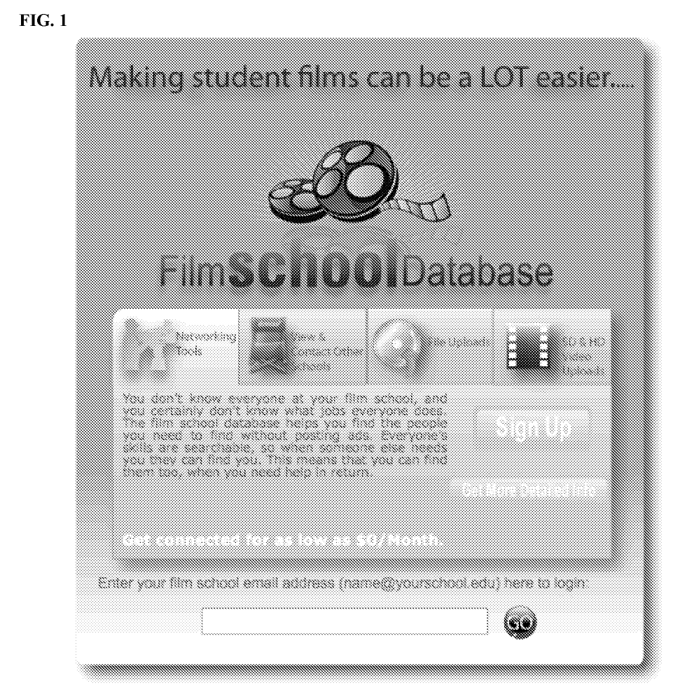

FIG. 2: The login page is pre-populated with the email address entered on the homepage, and provides a blank address field.

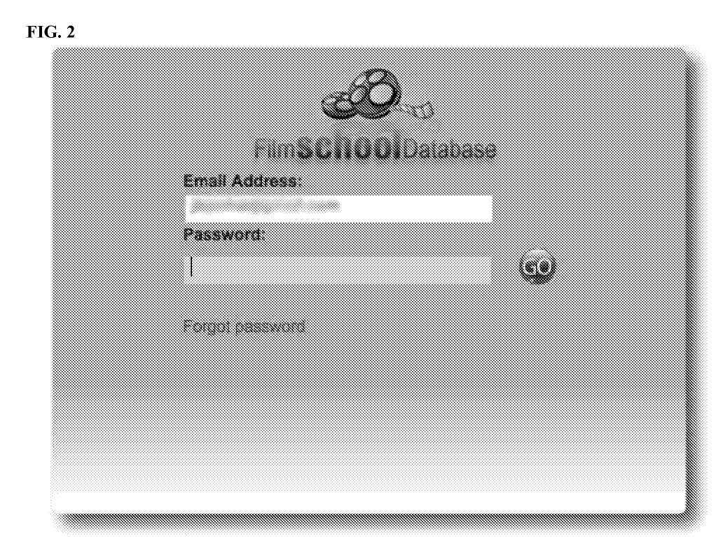

FIG. 3: The control panel provides an overview of the options offered by the service

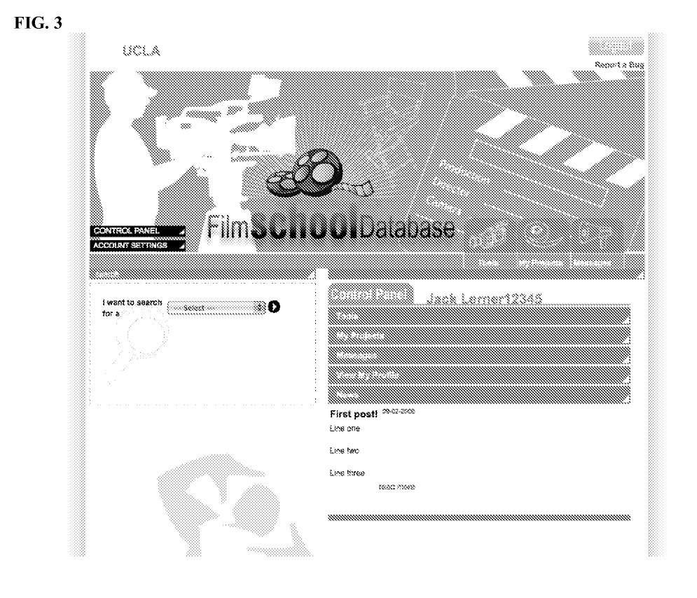

FIG. 4: The account settings page allows a student to change specific characteristics about their particular account and profile.

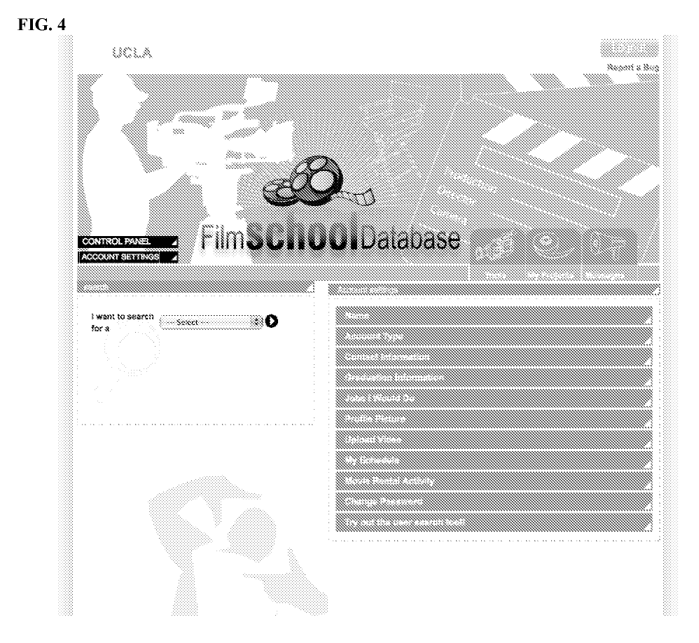

FIG. 5: The MyProjects page displays projects that the student is currently involved with, and was involved with in the past.

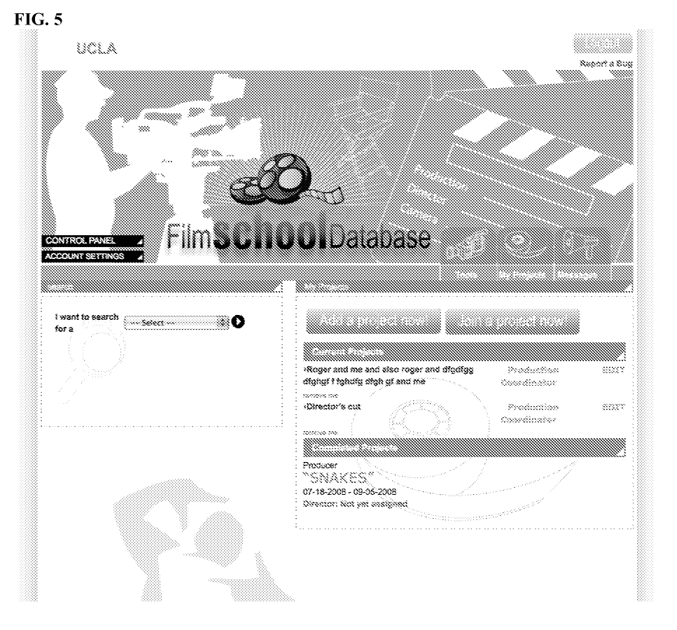

FIG. 6: The messages page offers a way to send an email or an SMS text message to another student, several students, or an entire crew.

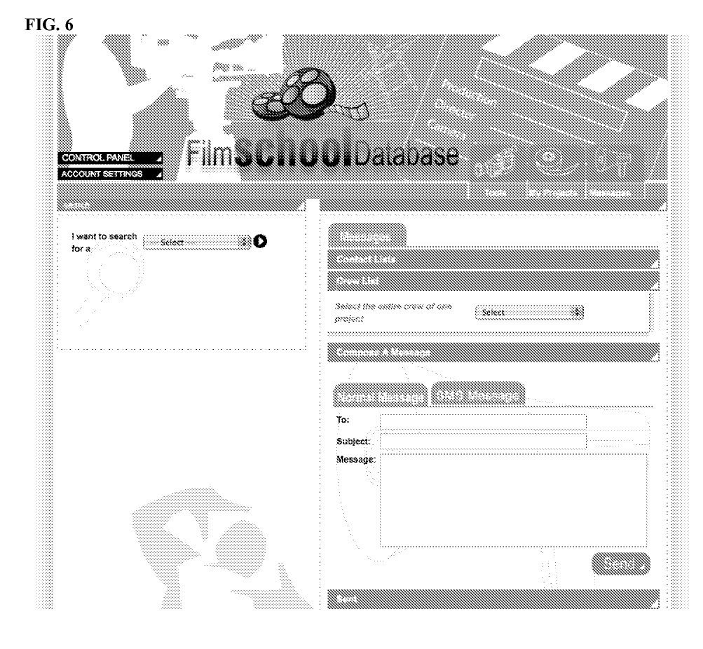

FIG. 7: The tools page contains links to extra tools offered to the student.

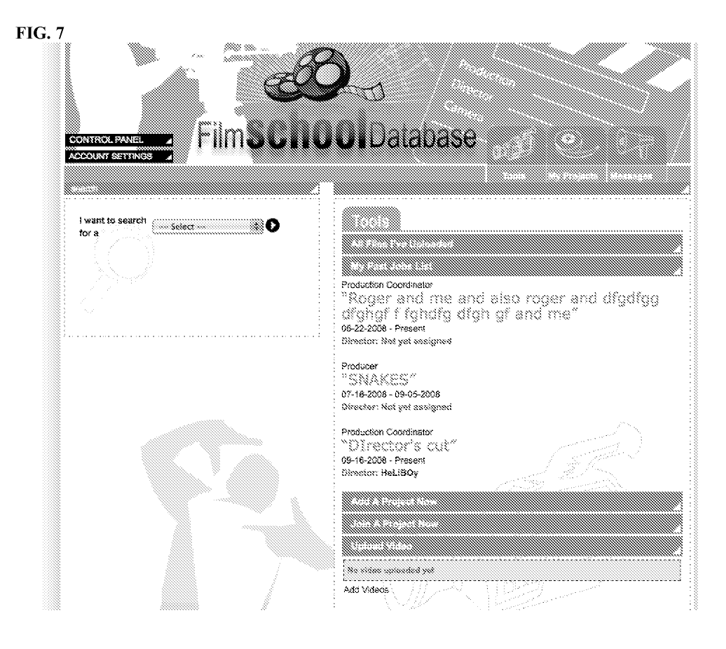

FIG. 8: The project search page allows one student to search for students' projects.

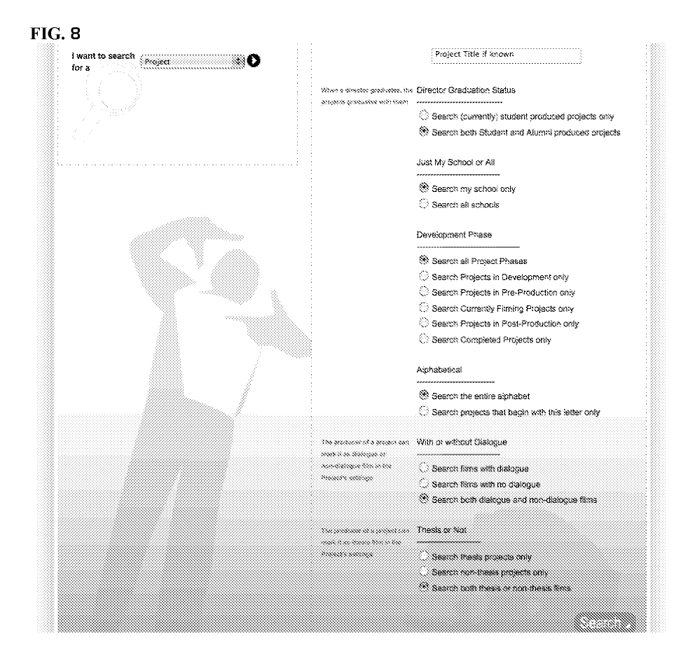

FIG. 9: The person search page allows students to search for other students.

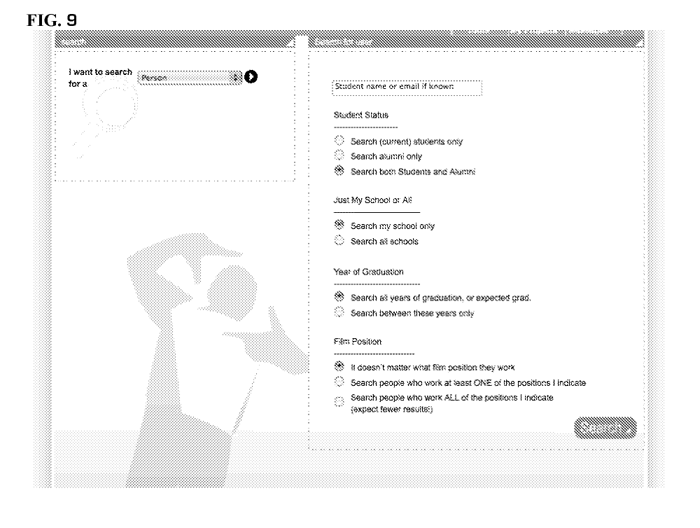

FIG. 10: The person results page displays sample results of a person search.

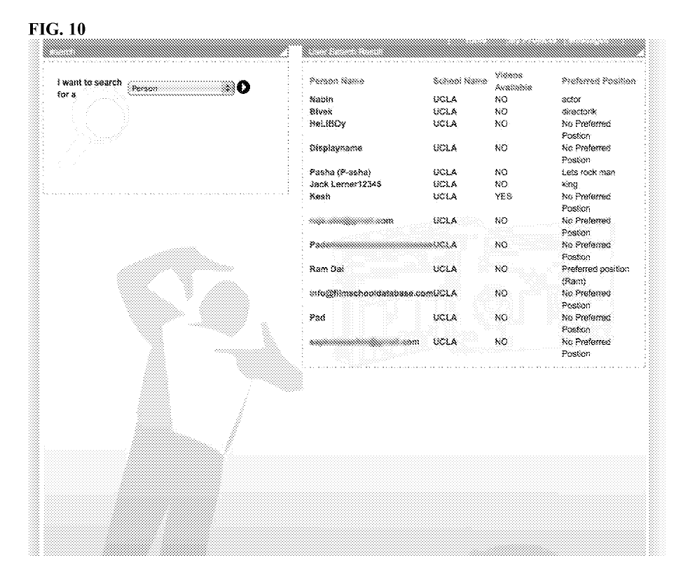

### DETAILED DESCRIPTION OF THE INVENTION

The Film School Database will allow every student attending subscribed film schools the ability to become a member. Each film school will potentially have a faculty admin account to add and modify certain items. Lastly, there will be the global admin account, to manage all of the schools.

The first version of the website runs on a Linux based server using PHP, MySQL and apache (LAMP). Additional storage for file uploads, and video files, and image uploads are stored on Amazon S3. The first version of the system uses a custom FFMPEG installation to encode uploaded videos for Flash based playback. The first version of the system uses “celltrust” as the SMS gateway to send SMS messages through their API.

After users have been granted access to the program, they will have the capability to create a personal profile, create projects, search for people and projects, send messages to other users, upload videos to their profiles and project profiles that they are associated with. Guests (non-users) of filmschooldatabase.com will only have access to PUBLIC pages, which will LACK (not have) search functionality, profile/project creation/editing functionality, etc.

PUBLIC users must have the appropriate “public password” to be able to view the corresponding public user or project profile pages.

Cataloguing and Linking is the main feature of the website. It allows for the creation and organization of student names and project titles from all registered schools. Projects and Students are linked to each other per their real world relationships to one another. Each element has a school related to it as well. Each student has a symbol next to their name revealing whether they are a student or alumni.

This catalogue can be browsed or searched by users. Search is customizable, with filter options to achieve the most relevant results for users.

The website is searchable in two main areas: 1) Students and Alumni and 2) Projects.

Projects can be searched and filtered: by school, dialogue or no dialogue, thesis film or not thesis beginning letter of the title, and phase of the project.

Students and Alumni can be searched by entering names or nicknames into the person search tool. The results can be filtered by graduation year (or expected graduation year), school, film crew position, and enrollment status.

Students create projects from within their accounts. If they would like to have it “certified” by faculty, they can indicate so in the project's properties. The project will then be submitted for certification to the faculty account.

Each school itself has its own simple profile which displays how many alumni users, student users, and total users it has. It also displays the number of users associated with each film crew position. This profile is not searchable, it is only found through links from students and projects originating from that school.

The “Add a Project” page contains fields asking “which class and which instructor”, not for publishing to other students, but only for faculty information during the certification process.

“Authorized” student positions, currently Producers, Directors, Unit Production Managers, and Production Coordinators of projects have access to an “Edit Project Information” section on the corresponding project on their “MyProjects” page. This allows them to change several production characteristics:

Specify (toggle) Dialogue/Non dialogue options

Thesis/Non-Thesis options can be changed, project Title can be changed, people's positions can be changed and approved, project pictures can be modified, and project info (synopsis) is written. Users have the ability to share their work with the world outside of the Film School Database by sharing their “public URL” which is currently formatted as www.filmschooldatabase.com/(schoolname)/(studentname)

It is important to note that guests will not be able to view public profiles of users without the user's public password, which is different for every user. The user can supply them with this. If a user wants to change this password to different random characters, there will be a button to do so.

Guests viewing these public user pages will be able to view limited information, but are able to watch the videos on these pages and send a message to a user. Guests do not have search capabilities, and will not be able to view the messages, tools, control panel, myprojects, or account settings screens. These buttons for users do not appear on the public pages.

Messaging and the contacts list makes use of the cataloguing feature. It allows for students to contact other students for the first time, or have discussions over periods of time. Users have the ability to group other users into a list called “contacts”. This list is accessible from the messaging page. These are also a shortcut, allowing users to avoid the task of searching for familiar contacts every time they need to look for them. Contacts are instantly added anytime a user sends another user a message. There is an “add to contacts” button on each user's profile. Messaging and contacts can be accessed by clicking the “messaging” button in the control panel.

Users are able to send messages to other users. These messages are routed to the email address the users have provided. The sender's email address is automatically inserted into the “reply to” field of the emails that are sent.

Users are able to send messages to multiple recipients.

Similarly, producers can send mass SMS messages to crew members that have their cell phone number on file. SMS message can not be sent to users who have not included their phone number in their account settings, or have not allowed SMS messaging.

The messaging system only shows names and schools. The contacts page itself has names and is clickable so that the contact's complete profile can be viewed.

Contact lists are private. Users do not know when they are on someone else's contact list.

Each profile has an “add to contacts” option.

The contacts page allows a user to select only crew members from particular a project as message recipients. A drop down list of projects is displayed for this purpose.

The account settings page offers each user the ability to embed a gmail calendar in their profile, in order for others to be able to view their schedule. If they choose to do so, all they need to do is enter their gmail.com email address.

Users are able to upload and name video files on their profiles. Authorized users are able to upload these types of files onto project pages.

A custom flash player appears for each movie uploaded by users

A chat room is available for online meetings, which everyone in the project can join. This chat room option is not visible to users who are not on the project's crew.

There is a space in each project for paid users to upload files up to 5 MB. The files remain on the server for 300 days unless a user resets the number of days. The project itself will remain online forever. This should only be visible by the crew affiliated with the project. The button to access it is on the project profile.

There is a link on each user's control panel which will take them to their account settings section.

When a user logs into their account for the first time, the account settings page is the default page they are directed to. (After their first time, the default page should be the control panel page, unless a user forgot their password. Then the default page becomes the account settings page again, and the page is moved directly to the “change password” section.) This account settings section contains most account. The page contains password change, email address, Searchable name, displayed name, privacy options, etc.

Once students have an account, they can change the email address that all correspondence is sent to, if they prefer another email address over the one assigned to them by the school. They can then login with either address.

Each user has skills sets that they can attach to their profiles. Other users can search for them based on what they need. If a producer is needed, for example, they can filter out all of the producers at their school.

Users can opt in or out of text messages (which can only be sent by fellow crew members in active projects).

Users have the option of how much information should be displayed on their profile. It is “recommended” that they display their email address and phone number, because the site is not searchable from the public internet, and cannot be accessed by “SPAMbots”.

Crew lists are automatically compiled in each project, and downloadable as a PDF file. This is a simple page containing a list of all of the users associated with each project, and their job they are performing on the film.

There is a simple “my past jobs” tool, listing a user's past jobs, with links to the projects and the directors' profiles.

When an account is created for a new school, a faculty admin account can be created. This account can only admin features within their school. This school faculty account will be the way to certify new projects. The faculty admin account can add/remove students from their school's database. When a faculty account is added, it is added along with a domain name for the email address of the school's student (such as studentname@ucla.edu). For example, if UCLA had an account, any email address ending with ucla.edu would be allowed to create an account (once the email address is verified).

All students will create their accounts and login beginning at filmschooldatabase.com. When the Film School Database is updated, each individual school's account and site will be updated as well.

The admin account has the capabilities of a faculty account, but with access to each school, with the ability to setup or remove school accounts.

I claim to have invented:

1. A system comprised of at least one database which catalogues higher education schools, in which said database only allows the cataloguing of higher education school which offer entertainment industry related classes and/or students and/or previous students and/or student projects within said higher education schools, wherein said system enables only students and/or faculty at said higher education schools to locate contact information and/or provide means of contact for other students who are intending to work in the entertainment industry.

2. A system as in claim 1, which is privately administered.

3. A system as in claim 1, which is in an electronic form.

4. A system as in claim 1, which is in the form of an internet website.

5. A system as in claim 1, which calls mobile phones and/or works in conjunction with an SMS gateway and/or modem to send SMS messages to mobile phones.

6. A system as in claim 1, which is privately administered and in an electronic form.

7. A system as in claim 1, which is privately administered, and in the form of an internet website.

8. A system as in claim 1, which is privately administered, and calls mobile phones and/or works in conjunction with an SMS gateway and/or modem to send SMS messages to mobile phones.

9. A website as in claim 1, which has a search feature and offers specific search filter options which can assist in resulting in a specific filtered list of search results.

10. A website as in claim 1, which has a search feature and allows users to filter results by past and/or present and/or preferred movie crew positions.

11. A website which only offers a membership to students and/or previous students who are and/or were enrolled in a higher education school which offers and/or offered entertainment industry related classes.

12. A website as in claim 11, which assists student and/or previous students from a plurality of higher education schools to communicate with one another.

13. A website as in claim 11, which assists students and/or alumni of a particular higher education school to communicate with one another, as well as assists student and/or previous students from different schools to communicate with one another.

13. A website as in claim 11, which assists students and/or alumni of a particular higher education school to communicate with one another, as well as assists student and/or previous students from different schools to communicate with one another, comprising of the ability to call mobile phones and/or work in conjunction with an SMS gateway and/or modem to send SMS messages to mobile phones.

15. A website as in claim 11, which has a search feature and offers specific search filter options which can assist in resulting in a specific filtered list of search results.

16. A website as in claim 11, which has a search feature and allows users to filter results by past and/or present and/or preferred movie crew positions.

17. A website comprised of a search feature dedicated to assisting users in finding students and/or previous students and or student projects within a particular higher education school which offers entertainment industry related classes.

18. A website as in claim 17, which offers specific search filter options which can assist in resulting in a specific filtered list of search results.

19. A website as in claim 17, which allows users to filter results by past and/or present and/or preferred movie crew positions.
